(19) United States
(12) Patent Application Publication
(10) Pub. No.: US 2005/0021854 A1
(43) Pub. Date: Jan. 27, 2005

(54) Method and system for providing a user with a presence service

(76) Inventor: Jorgen Bjorkner, Hagersten (SE)

Correspondence Address: BURNS DOANE SWECKER & MATHIS L L P, POST OFFICE BOX 1404, ALEXANDRIA, VA, 22313-1404, US

(21) Appl. No.: 10/821,329

(22) Filed: Apr. 9, 2004

Related U.S. Application Data
(63) Continuation of application No. PCT/SE02/01826, filed on Oct. 8, 2002.
(60) Provisional application No. 60/327,798, filed on Oct. 10, 2001.

(30) Foreign Application Priority Data
Oct. 10, 2001 (SE) 0103363-8

(51) Int. Cl. G06F 15/16

(52) U.S. Cl. 709/245

(57) ABSTRACT

A method and system for providing a user with a presence service includes a terminal having an application with addresses representing different objects. The terminal includes a presence program logic connected to the application, the presence program logic being connected to a presence managing system. The presence program logic includes interface interacting means for using at least one interface present in the application to integrate the presence service with the services of the application.

This application is a continuation of International Application No. PCT/SE02/01826, entitled “A Method and a System for Providing a User with a Presence Service,” filed on Oct. 8, 2002, which claims the benefit of U.S. Provisional Application No. 60/327,798, entitled “A Method and a System for Communication,” filed on Oct. 10, 2001, of which the disclosure of both are incorporated herein by reference.

### BACKGROUND

The present invention relates to a method and a system for providing a user with a presence service.

A presence service is a network service where subscribers to the service easily can inform each other about their availability and their willingness to communicate. Each subscriber has a list, called a buddy list, comprising presence addresses of the other subscribers he wants to have presence information from. The buddy list is located in and managed by a presence client which is installed in a terminal used by the subscriber.

The presence addresses point to some kind of presence system from which presence information about the concerned subscribers is retrieved. The presence system could be a presence server, which keeps updated information about the presence states of the subscribers having a presence address pointing to this presence server. Alternatively the presence information could be fetched directly from the clients. In this case the presence address points directly to the clients.

When a subscriber to the service wants to change his presence state he uses some kind of input means provided by the presence client. This change is forwarded to the presence system to which the presence address is pointing, for example a presence server. The presence states could be for example “present”, “not present” (the same as not connected to the network) or “present but unwilling to communicate”. The presence server notifies subscribers who have subscribed for presence information from this person. The notification comprises information about the changed presence state. However, only subscribers who are accepted by this person to receive his presence information will get the information.

The presence information is for example presented as icons. The icons could possibly also be accompanied by a text given by the user. The text could be information about the reason for a “not present” state.

Instant messaging is a communication service that is used to send short text messages over a network. Characteristic for an instant message is that it is displayed immediately on the recipients screen. The recipient may then send an answer message, and a series of message exchanges can turn into a chat session. Instant messaging services are normally combined with presence services.

A presence service is disclosed in for example WO 01/56308. Also instant messaging is disclosed in WO 01/56308.

A problem with existing systems is that they require a special user interface for presence services.

### SUMMARY

An object of the invention is to provide a more user friendly presence service.

A further object of the invention is to combine a presence service with applications having addresses representing different objects such as for example communication and collaboration applications.

This is achieved in a method of the initially defined kind comprising the steps of:
connecting a presence program logic to an application having addresses representing different objects and operating in a terminal belonging to the user;
connecting said presence program logic to a presence managing system;
utilising at least one interface present in the application to integrate the presence service with the services of the application.

Furthermore the object is achieved in a system as initially described. Said system comprises a terminal belonging to the user, said terminal comprising an application having addresses representing different objects. Said terminal further comprises a presence program logic connected to the application, said presence program logic being connected to a presence managing system. Furthermore the presence program logic comprises interface interacting means for utilising at least one interface present in the application to integrate the presence service with the services of the application.

Hereby a presence service is integrated into an application having addresses representing different objects. A PIM application, an address list in a mobile telephone and a time management system are examples of such applications. The user interface in the application will be used also for the presence service.

Suitably said application comprises interfaces for extensibility. These interfaces are preferably used for the integration of the presence service.

Suitably said interface interacting means is adapted to interact with an interface present in the application to retrieve addresses from an address list stored in the application for using them in the presence services.

Advantageously said system comprises traversing means connected to the interface interacting means adapted to traverse the address list in the presence program logic to find address properties relating to presence addresses.

Suitably the interface interacting means is adapted to interact with an existing interface in the application to extend the address items in the address list of the application to also contain presence addresses.

Hereby the address list in the application can be extended with presence information and the same address lists can be used for the presence service as for the ordinary application services.

In one embodiment the interface interacting means is adapted to interact with an existing interface in the application to extend a toolbar in the application to comprise icons representing the presence states of members in a buddy list given by the user.

Suitably the interface interacting means is adapted to interact with an existing interface in the application to extend the user interface to comprise input means for the user to use when he wants to change his presence state.

Hereby a user friendly user interface for the presence service, which is integrated with the user interface of the application is achieved.

In one embodiment the application is a PIM application.

The interface interacting means can be adapted to utilise an interface in the application to interact with a calendar or a reminder list in the application such that presence state changes could be performed automatically based on scheduled events in the calendar or the reminder list.

The terminal can further comprise an instant messaging, a telephone and/or a video program logic connected to the application.

In one embodiment the interface interacting means is adapted to utilise an interface in the application to interact with a calendar or a reminder list in the application such that instant messages could be sent automatically based on scheduled events in the calendar or the reminder list.

### BRIEF DESCRIPTION OF THE DRAWINGS

FIG. 1 shows an application having interfaces for extensibility which interacts with a presence program logic according to one embodiment of the invention.

FIG. 2 is a flowchart of a first embodiment of the invention.

### DETAILED DESCRIPTION

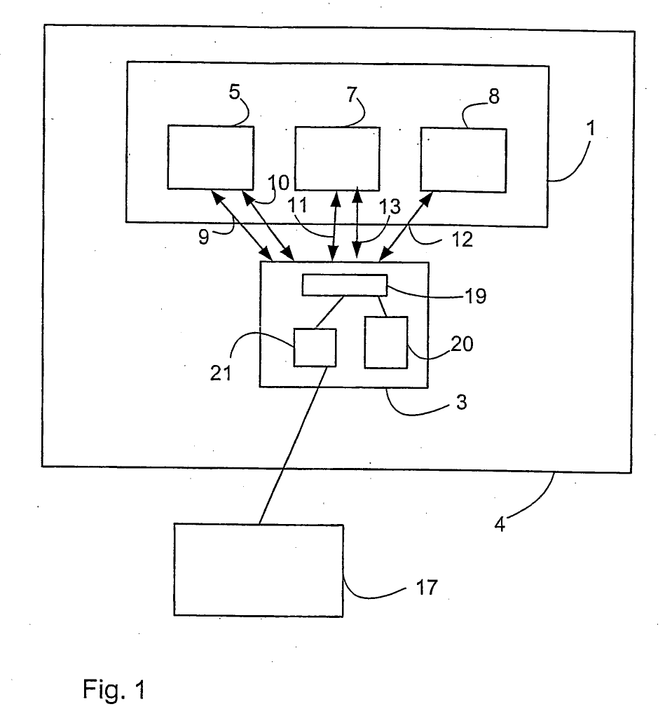

FIG. 1 shows an application 1 having interfaces for extensibility which interacts with a presence program logic 3 according to one embodiment of the invention. The application 1 is according to the invention an application to which it would be useful to add a presence service. It could for example be a communication or collaboration application, such as a PIM (Personal Information Management) application or an address lists in for example an intranet or a mobile telephone. The application 1 could also be a time management system or a project planing system. In this embodiment the application is a PIM application 1. The PIM application 1 and the presence program logic 3 are installed into the same user terminal 4, which could be for example a mobile telephone, a PDA (Personal Digital Assistant) or a PC (Personal Computer).

PIM applications have become widely used today and exist in both handheld devices and as software on computers. A PIM application is usually an application being a tool for managing a persons email communication, calendar events, to do lists and personal or corporate address lists.

The PIM application 1 comprises in this example an address list 5, a tool bar 7 and an address view 8. The presence program logic 3 comprises according to the invention an interface interacting means 19 adapted to interact with at least one interface present in the PIM application 1. The presence program logic 3 is in this embodiment in contact with at least one presence server 17. The presence serve 17 is responsible for performing subscriptions and notifications of presence information. In another embodiment of the invention further communication services are added to the application together with the presence service. This could be for example an instant messaging service, a telephone service, a video service or a white board service.

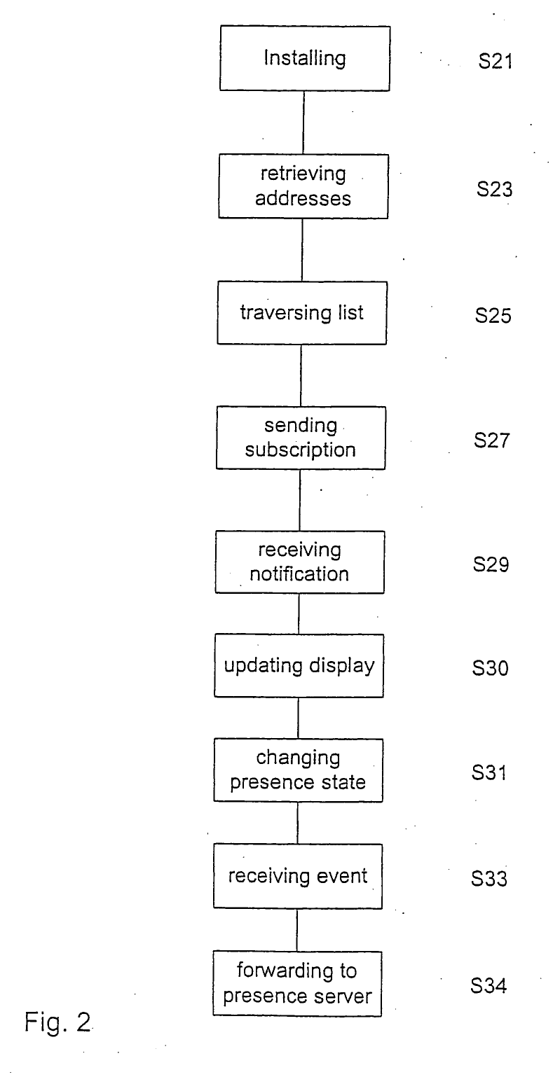

The important part of the invention is the communication between the presence program logic and in this case the PIM application over said already existing PIM application interface/s. This is described with reference to the flow chart of a first embodiment of the invention in FIG. 2. The steps of the communication procedure are described in order below:

S21: A presence program logic 3 is installed into a terminal 4 comprising a PIM application 1. The presence logic 3 is adapted to be loaded and executed upon start of the PIM application 1.

S23: The interface interacting means 19 in the presence program logic 3 uses an address retrieving interface 9 present in the PIM application 1 to retrieve the addresses stored in the address list 5 in the PIM application 1.

S25: A traversing means 20 connected to the interface interacting means 19 in the presence program logic 3 traverses the address list 5 and searches an address property indicating presence in each address item. This address property comprises a presence address which points to a presence system being responsible to receive and forward presence state changes to the participants of the service.

S27: A communication means 21 in the presence program logic 3 sends out presence subscriptions to the presence servers indicated by each presence address. These subscriptions implies that the presence servers will keep this presence program logic 3 updated with presence information from the indicated users. The presence program logic 3 is now responsible to keep a current presence state for all addresses having a presence property in the address list.

If the PIM application 1 has no native support for properties which refer to presence addresses an address item extending interface 10 is used to extend the address items with these properties. The user interface used for creation and manipulation of address items is also extended to support those properties. Each address item may also have a property associated that indicates to the presence program logic how this address should be represented in the user interface. For example there may be a property that indicates that an icon and a text line representing the address item and the presence state of that address should be displayed in the tool bar. A tool bar modification interface 11 is used to add such an address representation to the tool bar. This addition to the toolbar is performed when the traversing means 20 traverses the address list and such a property is encountered.

In one embodiment of the invention the presence program logic 3 has subscribed for an event to be generated when a user chooses to list the address book in the address view area 8 of the PIM application 1. Thus, when the address book is listed the presence program logic 3 gets information about this and the presence program logic 3 uses an address view modification interface 12 to add updated presence state information associated with the address items listed in the address view area. This allows for address information and presence information to be displayed in one single view.

S29: A presence state update notification is received in the communication means 21 in the presence program logic 3 from the presence server 17.

S30: The toolbar modification interface 11 and the address view modification interface 12 are used to update the display of the presence state of the entity associated with the received presence state update notification.

S31: The user of this terminal 4 will join a meeting and therefore he changes his presence state to “not present”. Suitably he uses some kind of input means in the toolbar 7 of the PIM application 1 for this purpose.

S33: An event is received in the presence program logic 3 about the change of presence state.

S34: This is forwarded to the presence server 17 associated with this user. The presence server 17 notifies the users who subscribes for presence information of this user about the changed presence state. This notification procedure is well known in the art and will not be described in more detail here.

The presence program logic 3 may use an input means adding interface 13 for adding input means to the PIM application user interface to allow the user of the

PIM application to set his own presence state. When this input means is used to change the user's presence state an event is raised and captured by the presence program logic 3 which will send a presence update message to the presence server 17.

If an instant messaging program logic is added to the PIM application together with the presence program logic a user interface modification interface, for example the tool bar modification interface 11, the address view modification interface 12 or the input means adding interface 13, could be used to add menus or buttons that allows the sending of an instant message from the user interface of the PIM application 1. When for example such a button is pressed an event will be sent to the instant messaging and presence program logic 3. This event contains the address of the receiver of the instant message. Instant messages addresses could be found by retrieving an instant messaging property from a selected address item in the address view. The address item extending interface 10 could be used to extend the address items with instant messaging addresses if this is not supported by the PIM application.

In one embodiment of the invention a calendar, a reminder list and/or a to do list in the PIM application is used to automatically change presence state and/or sending out instant messages.

Events generated by calendar items in the PIM application is sent to the presence program logic to cause presence update messages to be sent to the presence server. For example the presence state could be set to busy when the time for a scheduled meeting occurs and back to available again when the meeting has ended.

In the same way an instant message could be sent as a reminder to participants of a meeting when the time for the meeting set in a calendar is reached.

The above described embodiment was illustrated with a number of different interfaces with different names performing different tasks. However, it is possible that a single interface in the application having all these described functions is used instead. It is also possible that more interfaces than described here are utilised.

Furthermore, presence servers have in this described embodiment been used for the distribution and managing of presence information. This is however not necessary. The presence update notifications could also be transferred directly between the clients.

1. A method for providing a user with a presence service, comprising:
connecting a presence program logic to an application not already having functions for presence service, but having addresses representing different objects, comprising interfaces for extensibility and operating in a terminal belonging to the user;
connecting said presence program logic to a presence managing system; and
utilizing at least one interface present in the application to integrate the presence service with the services of the application.

2. The method according to claim 1, comprising:
using an interface present in the application to retrieve addresses from an address list stored in the application for use in the presence services.

3. The method according to claim 2, comprising:
traversing the address list by a traversing means in the presence program logic to find address properties relating to presence addresses.

4. The method according to claim 1, comprising:
utilizing an existing interface in the application to extend the address items in the address list of the application to also contain presence addresses.

5. The method according to claim 1, comprising:
utilizing an existing interface in the application to extend a toolbar in the application to comprise icons representing the presence states of members in a buddy list given by the user.

6. The method according to claim 1, comprising:
utilizing an existing interface in the application to extend the user interface to include input means for the user to use when he wants to change his presence state.

7. The method according to claim 1, comprising:
connecting the presence program logic to a PIM application operating in the terminal.

8. The method according to claim 1, comprising:
changing the presence state automatically depending on information in a calendar or a reminder list in the application, the interaction between the calendar or the reminder list and the presence program logic being performed through an interface already existing in the application.

9. The method according to claim 1, comprising:
adding at least one of an instant messaging, a telephone, and a video program logic to the application.

10. The method according to claim 9, comprising:
sending an instant message automatically depending on information in a calendar or a reminder list comprised in the application, the interaction between the calendar or the reminder list and the instant messaging program logic being performed through an interface already existing in the application.

11. A system for providing a user with a presence service, comprising a terminal having an application not already having presence service functions but having addresses representing different objects, and interfaces for extensibility, the terminal including a presence program logic connected to the application, said presence program logic being connected to a presence managing system, the presence program logic having interface interacting means for utilising at least one interface present in the application to integrate the presence service with the services of the application.

12. The system according to claim 11, wherein the interface interacting means is adapted to interact with an interface present in the application to retrieve addresses from an address list stored in the application for use in the presence services.

13. The system according to claim 12, comprising:
traversing means connected to the interface interacting means adapted to traverse the address list in the presence program logic to find address properties relating to presence addresses.

14. The system according to claim 11, wherein the interface interacting means is adapted to interact with an existing interface in the application to extend the address items in the address list of the application to also contain presence addresses.

15. The system according to claim 11, wherein the interface interacting means is adapted to interact with an existing interface in the application to extend a toolbar in the application to include icons representing the presence states of members in a buddy list given by the user.

16. The system according to claim 11, wherein the interface interacting means is adapted to interact with an existing interface in the application to extend the user interface to include input means for the user to use when he wants to change his presence state.

17. The system according to claim 11, wherein the application is a PIM application.

18. The system according to claim 11, wherein the interface interacting means is adapted to use an interface in the application to interact with a calendar or a reminder list in the application such that presence state changes could be performed automatically based on scheduled events in the calendar or the reminder list.

19. The system according to claim 11, wherein the terminal further comprises at least one of an instant messaging, a telephone, and a video program logic connected to the application.

20. The system according to claim 19, wherein the interface interacting means is adapted to use an interface in the application to interact with a calendar or a reminder list in the application such that instant messages could be sent automatically based on scheduled events in the calendar or the reminder list.
